(19) United States
(12) Patent Application Publication
(10) Pub. No.: US 2024/0322275 A1
(43) Pub. Date: Sep. 26, 2024

(54) Monitoring Device for an Electric Energy Storage Device, Comprising a Molded Part, Electric Energy Storage Device, and Motor Vehicle

(71) Applicant: Bayerische Motoren Werke Aktiengesellschaft, Muenchen (DE)

(72) Inventor: Torsten FRANKE, Muenchen (DE)

(21) Appl. No.: 18/271,685

(22) PCT Filed: Feb. 9, 2022
(86) PCT No.: PCT/EP2022/053061

§ 371 Date: Jul. 11, 2023

(30) Foreign Application Priority Data
Mar. 5, 2021 (DE) 10 2021 105 363.3

(51) Int. Cl. H01M 10/48; H01M 10/42

(52) U.S. Cl. CPC H01M 10/482; H01M 10/425; H01M 2010/4271; H01M 2010/4278; H01M 2220/20

(57) ABSTRACT

A monitoring device is provided for at least two energy storage device components of an electric energy storage device that includes a waveguide, which is designed in the form of a single-piece molded part to transmit acoustic and/or optical signals between devices, and at least one controller of the energy storage device in order to monitor the energy storage device components. The molded part forms a transmission network and has at least one collecting channel for connecting to the at least one controller and at least two connection channels connected to the at least one collecting channel for connecting to the devices of the at least two energy storage device components. The acoustic and/or optical signals can be transmitted within the molded part in a bidirectional manner between the devices of the energy storage device components and the at least one controller via the collecting channel and the connection channels.

### BACKGROUND AND SUMMARY OF THE INVENTION

The invention relates to a monitoring device for at least two energy storage components of an electric energy storage device, comprising a waveguide which is designed to transmit acoustic and/or optical signals between units of the energy storage components and at least one controller of the energy storage device to monitor the energy storage components. The invention additionally relates to an electric energy storage device and a motor vehicle.

In the present case, interest is directed to electric energy storage devices which can be used, for example, as traction batteries for electrified motor vehicles, thus electric or hybrid vehicles. Such electric energy storage devices typically include an interconnection made up of multiple energy storage cells and at least one controller. To monitor energy storage components of the energy storage device, for example, the energy storage cells, it is known from the prior art that the energy storage components and the controller exchange signals via sensors and actuators, for example, control signals and information signals having cell-specific key figures. The signal transmission can be carried out in a wired manner here, for example. However, the high expenditure for the signal transmission between the sensors and actuators, which are subject to different potentials, and the higher-order controller and also the restricted packaging capability of the components used for this purpose are disadvantageous here. Equipping an energy storage device with waveguides to produce a galvanic isolation between the sensors and the controller is also known from the prior art, for example DE 10 2017 110 326 A1.

It is an object of the present invention to design a waveguide for signal transmission of an electric energy storage device to be particularly simple and cost-effective.

This object is achieved according to the invention by a monitoring device, an electric energy storage device, and a motor vehicle having the features according to the respective independent claims. Advantageous embodiments of the invention are the subject matter of the dependent claims, the description, and the figures.

A monitoring device according to the invention for at least two energy storage components of an electric energy storage device includes a waveguide, which is designed to transmit acoustic and/or optical signals between units of the energy storage components and at least one controller of the electric energy storage device to monitor the energy storage components. The waveguide is designed as a one-piece molded part. The molded part forms a transmission network and for this purpose includes at least one collection channel for connection to the at least one controller and at least two connection channels connected to the at least one collection channel for connection to the units of the at least two energy storage components. The acoustic and/or optical signals are transmittable bidirectionally within the molded part via the collection channel and the connection channels between the units of the energy storage components and the at least one controller.

The invention additionally includes an electric energy storage device having at least two energy storage components, at least one controller, and a monitoring device according to the invention. The electric energy storage device can be, for example, a rechargeable traction battery or a traction accumulator, which can be designed as a high-voltage energy storage device. The energy storage components can be, for example, energy storage cells, connecting lines, etc. The energy storage cells can be designed, for example, as prismatic energy storage cells, round cells, or pouch cells. The energy storage components can be arranged jointly with the at least one controller in a housing interior of an energy storage device housing.

For monitoring the energy storage components, the energy storage components can include monitoring elements, which acquire at least one component-specific key figure, for example, a temperature, a cell voltage, a cell impedance, or a cell pressure. This at least one key figure is transmitted as a signal to the controller. In the case of energy storage cells, the monitoring elements can also be a balancing circuit for carrying out a state of charge equalization between the energy storage cells or disconnecting switches for isolating a defective energy storage component. These monitoring elements can be activated by the controller via control signals. The signal transmission takes place here via electromagnetic waves or light, thus optical signals, and/or sound waves, thus acoustic signals, between the energy storage components and the at least one controller. The monitoring elements are integrated, for example, in the units of the energy storage components.

The transmission medium is a waveguide, which is designed as a one-piece molded part. The one-piece molded part is designed to couple at least two energy storage components to the at least one controller in a potential-free manner and for this purpose includes the at least one collection channel and the connection channels connected thereto. The molded part is a finished part, which can be arranged on the energy storage components and the at least one controller by only one installation step. The molded part thus does not consist of individual parts, which have to be connected or wired to one another, but rather already provides a one-piece transmission network for signal transmission. Upon the arrangement of the molded part, the connection channels are arranged at the units of the energy storage components and the at least one collection channel is arranged at the at least one controller.

The at least one collection channel and the at least two connection channels preferably form a transmission network in the form of a bus network. The waveguide is thus designed as a data bus. To communicate with the controller, a unit of an energy storage component couples an optical and/or acoustic signal into the associated connection channel, which is transmitted via the connection channel and the collection channel and is decoupled again at the collection channel. To communicate with an energy storage component, the controller couples an optical and/or acoustic signal into the collection channel, which is transmitted via the collection channel and the connection channel and is decoupled again at the connection channel of the respective energy storage cell. The communication takes place here in particular by means of raw data or via a protocol.

Each energy storage component can be assigned, for example, a specific wavelength or corresponding signal band of the electromagnetic wave and/or sound wave.

In particular, transmitting elements or actuators for signal generation and receiving elements or sensors for signal reception are connected to the at least one collection channel and the at least two connection channels. In the case of optical signals, the transmitting elements are, for example, LEDs and the receiving elements are photodetectors. In the case of acoustic signals, the transmitting elements are, for example, loudspeakers and the receiving elements are, for example, microphones. The transmitting and receiving elements are part of the monitoring device and are integrated on the energy storage component side in particular in the units. The units can be designed, for example, as single-chip solutions.

The molded part can be designed as a hollow body, for example, in which the signal is transmitted via a reflection on insides of walls of the hollow body. Such a molded part can be a tube system, in which the tubular connection channels branch off from the tubular collection channel. The molded part is particularly preferably formed as a solid body, wherein the solid body includes surfaces or surface structures, which form areas for signal coupling and signal decoupling of the at least one collection channel and the at least two connection channels. The solid body is manufactured, for example, from a plastic, for example polyacrylic. The molded part is preferably formed as an injection molded part. For example, surfaces of the solid body can be ground or etched in areas to form the surface structure, in order to form the areas for signal coupling and signal decoupling. Such a molded part can be manufactured in a particularly simple and cost-effective manner.

It can be provided that the at least two connection channels and/or the at least one collection channel include channel sections extending nonlinearly, which have a curvature angle of, for example, equal to or greater than 90°, due to which passing on the signal presumes special formations of the waveguide. In order to ensure that the signal can be passed on by means of reflection, the nonlinearly extending signal sections include bevels or roundings, at which the signal can be reflected and thus guided through the molded part. In a simple embodiment, the guiding of the signal in the waveguide takes place due to different material properties, for example, index of refraction, of the waveguide and the surroundings of the waveguide.

In one advantageous embodiment of the invention, the molded part includes a coating made of a reflective material at least in some areas to reduce damping of the acoustic and/or optical signal. Such a coating is applied outside the areas provided for signal coupling and signal decoupling. The coating can be a metallization, for example.

The invention additionally includes a motor vehicle having at least one electric energy storage device according to the invention. The electrified motor vehicle is in particular a passenger vehicle.

The embodiments presented with reference to the monitoring device according to the invention and their advantages apply accordingly to the electric energy storage device according to the invention and to the motor vehicle according to the invention.

Further features of the invention result from the claims, the figures, and the description of the figures. The features and combinations of features mentioned above in the description and the features and combinations of features mentioned hereinafter in the description of the figures and/or solely shown in the figures are usable not only in the respective specified combination but also in other combinations or alone.

The invention will be explained in more detail on the basis of a preferred exemplary embodiment and with reference to the drawings. In the figures:

### BRIEF DESCRIPTION OF THE DRAWINGS

FIG. 1 shows a schematic representation of an embodiment of an electric energy storage device in a top view; and

FIG. 2 shows the electric energy storage device according to FIG. 1 in a side view.

### DETAILED DESCRIPTION OF THE DRAWINGS

In the figures, identical and functionally-identical elements are provided with identical reference signs.

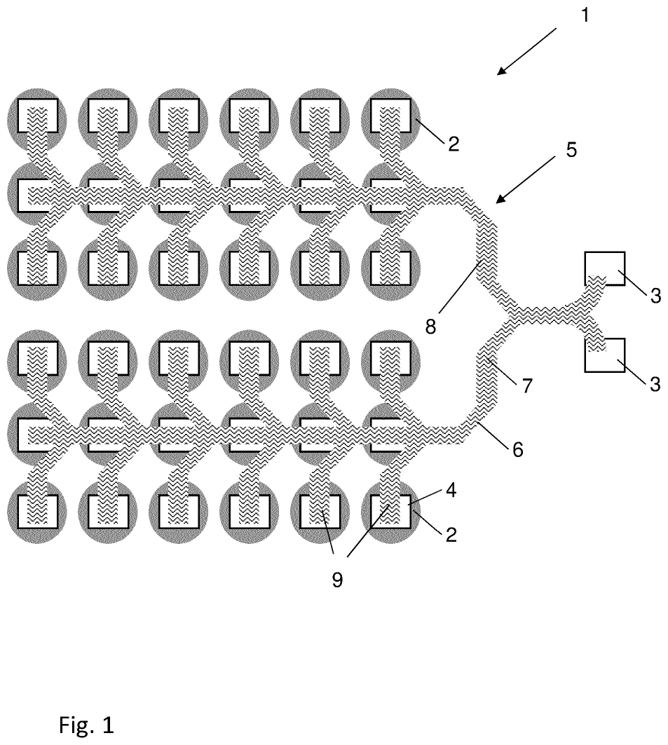

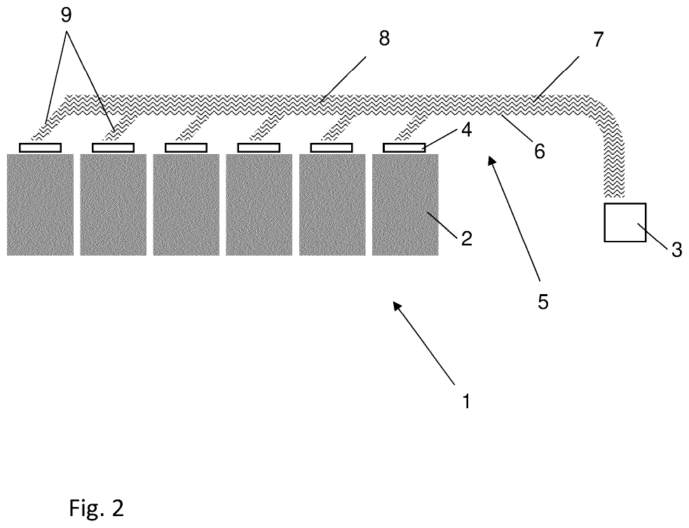

FIG. 1 and FIG. 2 show an electric energy storage device 1, in particular for an electrically drivable motor vehicle. The energy storage device 1 includes a plurality of energy storage components 2, energy storage cells here. The energy storage cells 2 are designed as round cells and are interconnected to form two cell packets. In addition, the energy storage device 1 includes two controllers 3, which are designed as redundant to one another, for example. Each energy storage cell 2 includes a unit 4 having monitoring elements. The monitoring elements can be, for example, voltage sensors, temperature sensors, impedance meters, a balancing circuit, a load break switch, or the like. The voltage supply of these monitoring elements can take place via the respective energy storage cell 2. The monitoring elements of the unit 4 can be attached to a separate carrier of the unit 4 or directly on or in the energy storage cells 2 or other energy storage components to be monitored.

The energy storage device 1 additionally includes a monitoring device 5 for monitoring the energy storage cells 2, which includes a waveguide 6 for transmitting signals between the units 4 and the controllers 3. The waveguide 6 is designed to transmit acoustic and/or optical signals. The monitoring device 5 is described hereinafter with respect to the implementation using light, thus optical signals, as the information carrier. The statements apply similarly to an implementation using sound, thus acoustic signals, as the information carrier. A protocol is preferably used for transmitting the items of information between the higher-order controllers 3 and the units 4. The protocol can be based on known standards adapted for optical signal transmission (LIN, CAN, WLAN, Bluetooth, NFC, ethernet, etc.). To improve the signal specificity, separate spectral bands can be assigned to the individual information flows of the monitoring device 5.

The waveguide 6 is thus designed here as a light guide. The monitoring device 5 additionally includes transmitting elements or actuators for emitting the optical signals, for example, LEDs, and receiving elements or sensors for receiving optical signals, for example, photodiodes, which can be integrated in the units 4 on the energy storage cell side. In one particularly advantageous embodiment, these transmitting elements, the receiving elements, and the monitoring elements of an energy storage cell 2 are designed as a single-chip solution. The controller 3 additionally includes a storage unit for storing an identifier and acquired data, a communication module for generating and processing the associated protocols, a signal processor for processing the signals and comparing them to predetermined or calculated system setpoint values, a communication interface to further controllers, and a voltage supply.

The signal transmission can include different modes for standard operation and for operating ranges outside the standard operation. In standard operation, the higher-order controller 3 assigns control commands to individual sensors or actuators or groups of sensors and actuators and retrieves data collected by sensors or actuators in a targeted manner. In operating ranges outside the standard operation, the sensors or actuators transmit an interrupt signal or an expanded emergency signal to the higher-order controller 3, by which safety routines can be triggered for the further operation of the energy storage device 1. The safety routines can act on the sensors or actuators and also on further controllers and elements and differ in accordance with the type of the interrupt or expanded emergency signal.

The waveguide 6 is a one-piece molded part 7. For example, the molded part 7 can be an injection molded part made of a plastic transparent to the spectral range used of the optical signal and can use the difference of the index of refraction between the plastic and the adjoining material, for example, air, for the light guiding in the interior of the molded part 7. The molded part 7 forms at least one data bus in this case, two data buses here for reasons of redundancy, which each include a collection channel 8 and one connection channel 9 per unit 4. The collection channel 8 is connected to the respective controller 3 and the connection channels 9 branch off from the collection channel 8. The waveguide 6 can penetrate a housing of the respective cell packet here and pass on the signals to the controller 3 arranged outside the housing. It can be provided in this case that the molded part 7 is mirrored on the surfaces not provided for a light passage to reduce the signal damping. Such a one-piece molded part 7 can be manufactured in a simple and cost-effective manner and installed without wiring expenditure on the units 4 and the controllers 3. The installation of the one-piece molded part 7 on the respective units 4 and the controller 3 can take place spaced apart, in a formfitting manner, or adhesively, for example, by a transparent adhesive.

1.-10. (canceled)

11. A monitoring device for at least two energy storage components of an electric energy storage device, including a waveguide, which is designed to transmit acoustic and/or optical signals between units of the energy storage components and at least one controller of the electric energy storage device to monitor the energy storage components, wherein
the waveguide is designed as a one-piece molded part, which forms a transmission network and which includes at least one collection channel for connection to the at least one controller and at least two connection channels connected to the at least one collection channel for connection to the at least two units for monitoring the energy storage components, wherein the acoustic and/or optical signals are transmittable within the molded part via the at least one collection channel and the connection channels bidirectionally between the units for monitoring the energy storage components and the at least one controller.

12. The monitoring device according to claim 11, wherein the at least one collection channel and the at least two connection channels form a transmission network in the form of a bus network.

13. The monitoring device according to claim 11, wherein the molded part is designed as a solid body, wherein the solid body includes surface structures, which form areas for signal coupling and signal decoupling of the at least one collection channel and the at least two connection channels.

14. The monitoring device according to claim 12, wherein the molded part is designed as a solid body, wherein the solid body includes surface structures, which form areas for signal coupling and signal decoupling of the at least one collection channel and the at least two connection channels.

15. The monitoring device according to claim 13, wherein the molded part is designed as an injection molded part.

16. The monitoring device according claim 11, wherein the molded part is manufactured from PMMA.

17. The monitoring device according claim 12, wherein the molded part is manufactured from PMMA.

18. The monitoring device according claim 13, wherein the molded part is manufactured from PMMA.

19. The monitoring device according to claim 11, wherein the at least two connection channels and/or the at least one collection channel include channel sections extending nonlinearly, which include an angle of curvature.

20. The monitoring device according to claim 12, wherein the at least two connection channels and/or the at least one collection channel include channel sections extending nonlinearly, which include an angle of curvature.

21. The monitoring device according to claim 13, wherein the at least two connection channels and/or the at least one collection channel include channel sections extending nonlinearly, which include an angle of curvature.

22. The monitoring device according to claim 11, wherein the molded part includes a coating made of a reflective material at least in some areas to reduce a damping of the acoustic and/or optical signal.

23. The monitoring device according to claim 12, wherein the molded part includes a coating made of a reflective material at least in some areas to reduce a damping of the acoustic and/or optical signal.

24. The monitoring device according to claim 13, wherein the molded part includes a coating made of a reflective material at least in some areas to reduce a damping of the acoustic and/or optical signal.

25. The monitoring device according to claim 11, wherein the monitoring device includes transmitting elements for signal generation and receiving elements for signal reception, which are connected to the at least one collection channel and the at least two connection channels and which are integrated on the energy storage component side in the units.

26. The monitoring device according to claim 12, wherein the monitoring device includes transmitting elements for signal generation and receiving elements for signal reception, which are connected to the at least one collection channel and the at least two connection channels and which are integrated on the energy storage component side in the units.

27. The monitoring device according to claim 13, wherein the monitoring device includes transmitting elements for signal generation and receiving elements for signal reception, which are connected to the at least one collection channel and the at least two connection channels and which are integrated on the energy storage component side in the units.

28. An electric energy storage device comprising at least two energy storage components, at least one controller, and at least one monitoring device according to claim 11.

29. A motor vehicle comprising at least one electric energy storage device according to claim 28.
